(19) United States
(12) Patent Application Publication
(10) Pub. No.: US 2004/0187385 A1
(43) Pub. Date: Sep. 30, 2004

(54) Method and apparatus for delivering natural gas to remote locations

(75) Inventors: William Perkins, Houston, TX (US); Jeffrey P. Beale, Elkridge, MD (US)

Correspondence Address: VINSON & ELKINS L.L.P., 1001 FANNIN STREET, 2300 FIRST CITY TOWER, HOUSTON, TX, 77002-6760, US

(73) Assignee: Small Ventures USA LLC

(21) Appl. No.: 10/822,451

(22) Filed: Apr. 12, 2004

Related U.S. Application Data
(63) Continuation of application No. 09/930,547, filed on Aug. 15, 2001.
(60) Provisional application No. 60/255,678, filed on Dec. 14, 2000.

(51) Int. Cl. F17C 1/00; F17D 1/04

(52) U.S. Cl. 48/190

(57) ABSTRACT

Initially, a ship containing LNG sails to an existing offshore natural gas pipeline. Such pipelines are often found on offshore natural gas platforms. The ship containing LNG then connects to a gasification device, which may be located on the ship, the platform, or on another ship (e.g., a barge). This gasification device, in turn, connects to the pipeline and supplies the pipeline with natural gas. In this manner, natural gas can be supplied to an existing pipeline without involving a land-based gasification device.

### REFERENCE TO EARLIER FILED APPLICATION

This application is a continuation of application Ser. No. 09/930,547, filed Aug. 15, 2001, which claims the benefit of U.S. Provisional Application No. 60/255,678, filed Dec. 14, 2000.

### BACKGROUND OF THE INVENTION

1. Technical Field

The present invention generally relates to the transportation and delivery of petroleum products. More specifically, in one embodiment of the present invention, the present invention provides for the delivery of liquefied natural gas from a water-based storage facility to land over existing natural gas pipelines.

2. Description of the Related Art

Natural gas has long been recognized as a clean burning alternative to coal and oil. Transporting natural gas over long distances, however, has always presented problems. Traditionally, networks of pipelines have been created and maintained to move natural gas from one point to another. As the price of energy rises, another alternative emerges: liquefied natural gas. Natural gas, when cooled to very low temperatures (e.g., less than −250 degrees Fahrenheit) compresses to 1/600th of its normal volume and turns into a liquid. This liquefied natural gas (LNG) can then be transported by ocean-going tankers, much like oil.

Transporting the LNG to a given location is but one part of the problem. Another obstacle is that once the LNG reaches its destination, it must be turned into a gas and inserted into the existing natural gas pipeline. Traditionally, these gasification facilities are located on the land. However, basing such facilities there often subjects the facilities to regulation by various governmental authorities and “not in my backyard” issues. Also, in the event of a potential fire or LNG spill at a land-based gasification facility, nearby buildings and persons are subjected to hazardous conditions. Thus, the need exists for a method of transporting LNG from one point to another, and making the gas widely available at the destination bypassing the traditional difficulties.

### SUMMARY OF THE INVENTION

Generally, the present invention is a method and apparatus for transporting liquefied natural gas and inserting it into an existing natural gas pipeline. Initially, a ship containing LNG sails to an existing offshore natural gas pipeline, such as an underutilized pipeline from an offshore oil or gas production platform. The ship containing LNG then connects to a gasification device, which maybe located on the transporting ship, an offshore platform, or on another ship, barge or floating platform This gasification device, in turn, connects to the pipeline and supplies the pipeline with natural gas. In this manner, natural gas can be supplied to an existing pipeline without involving a land-based gasification device.

### BRIEF DESCRIPTION OF THE DRAWINGS

The invention, as well as a preferred mode of use, further objectives and advantages thereof, will best be understood by reference to the following detailed description of an illustrative embodiment when read in conjunction with the accompanying drawings, wherein:

FIG. 1 illustrates an arrangement of devices for delivering natural gas to a remote location;

FIG. 2 is a flowchart depicting a method of delivering natural gas to a remote location; and

FIG. 3 shows the location of one place where the present invention can be implemented.

### DETAILED DESCRIPTION OF THE INVENTION

This disclosure describes the equipment and other devices necessary for delivering significant quantities of natural gas to remote areas, and a method for using the same. Generally, the present invention is comprised of one or more ships containing liquefied natural gas (LNG), and the equipment necessary to 1) pressurize and convert the LNG into gaseous natural gas, and 2) inject the gas into a pipeline. A water-based approach to transporting the LNG and converting the LNG into gaseous natural gas has several advantages over other alternatives. Using ships to transport LNG allows large quantities of LNG to be delivered quickly and safely to many different locations. In addition, basing the gasification equipment on a ship as well eliminates the requirement that a ship containing LNG must dock at ports that have land-based gasification facilities. In addition, the present invention allows for natural gas to be supplied from a relatively long distance offshore. This ability can provide an additional safety margin and can possibly minimize regulatory burdens that would otherwise hamper the use of such equipment on-shore or near the shore.

FIG. 1 illustrates several devices which comprise the present invention. LNG ship 102 contains the natural gas that is to be delivered to the remote location. LNG ship 102 can be implemented using any ship, barge, or other floating platform that is capable of transporting LNG from one point to another, and off-loading the LNG as will be described below.

LNG ship 102 is attached to gasification device 106 by connection 104. Gasification device 106 converts the LNG supplied from LNG ship 102 into a gaseous state suitable for injection into an existing natural gas pipeline system. Gasification device 106 contains pressure regulators to regulate the flow of gas (and the pressure at which the gas flows). Gasification device 106 is mounted on barge 108. However, the gasification equipment may also be contained on LNG ship 102. Like LNG ship 102, barge 108 should be capable of operating in a marine environment. Beside a barge, other floating platforms can be used. In one embodiment, the LNG can be converted into natural gas by applying heat to the LNG through a vaporizer. These vaporizers can be a submerged combustion type, a direct-fired type, open rack type, and shell and tube type. These vaporizers can use heat from remote sources, such as gas-fired water-glycol heaters, condenser water from a steam power turbine, and waste heat from some remote source.

After the LNG is gasified, it is compressed by LNG pumps 109 before being inserted into pipeline 110. The gas can be pressurized by a variety of LNG pumps, such as centrifugal pumps, positive displacement pumps, multi-stage pumps, and submerged motor, vessel mounted pumps.

Once the gas is pressurized, it is inserted into pipeline 110 through connection 112. Pipeline 110 can be any existing natural gas pipeline that is further connected to a larger grid of natural gas pipelines. In the alternative, pipeline 110 can simply lead to a storage facility or to a consumer of natural gas (e.g., a gas fired power plant). In a preferred embodiment, pipeline 110 is an existing pipeline running between an off-shore gas well and a network of on-shore pipelines. Pipelines associated with oil wells, oil or gas production platforms, or other offshore petroleum platforms can be used.

Not shown in FIG. 1 are the various compressors, pumps and other equipment necessary to move the natural gas from the LNG ship to the pipeline, as the inclusion and proper use of such devices is within the knowledge of one of ordinary skill in the art.

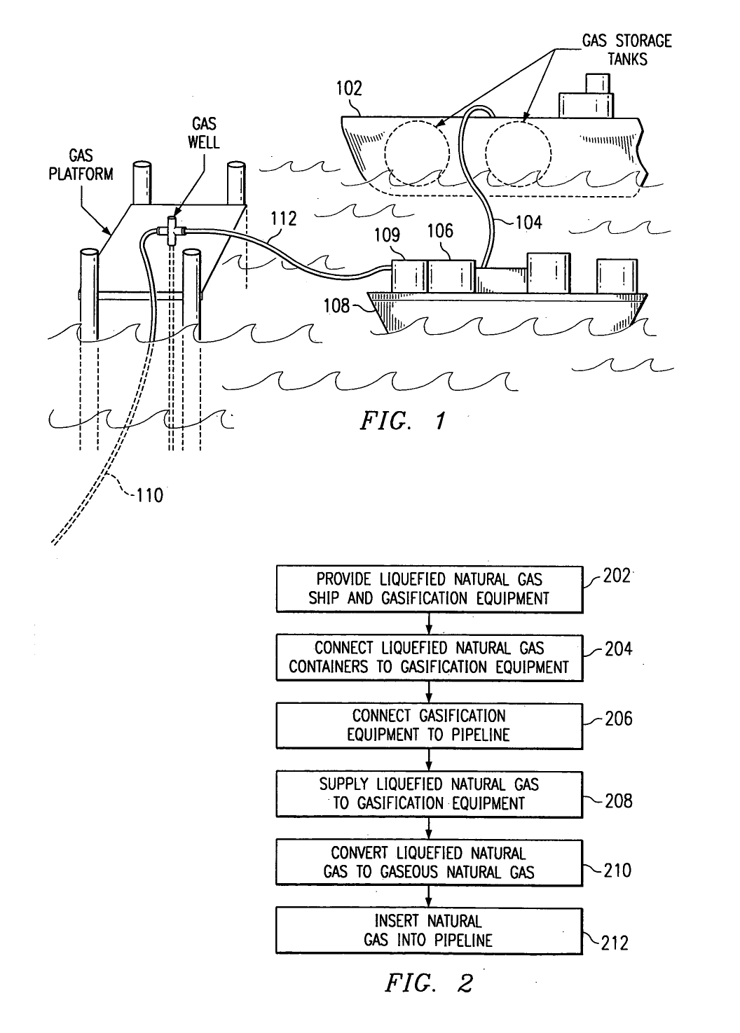

FIG. 2 is a flowchart describing the operation of the equipment shown in FIG. 1. Initially, the LNG ship and the barge containing the gasification equipment are provided at a location where the gasification equipment can access a natural gas pipeline (202). Next, the containers of LNG on the LNG ship are connected to the inputs of the gasification equipment on the barge (204). Also, the output of the gasification equipment is connected to the natural gas pipeline (206). Once the proper connections are made, the LNG ship begins to supply LNG to the gasification equipment (208). The gasification equipment, in turn, converts the liquefied gas into gaseous natural gas (210). This gas is then pressurized by pumps and inserted into the pipeline for distribution and/or consumption (212).

In another embodiment of the present invention, the process described in FIG. 2 can be reversed and used to extract natural gas from a pipeline. In such a process, gas liquidization equipment is substituted for the gasification equipment. This process allows gas to be extracted from an off-shore pipeline, liquefied, and inserted into a LNG ship for transport to another location.

In yet other embodiments, the gasification liquidization equipment can be based on the gas platform, thereby eliminating the need to base this equipment on barge 108. This option has the advantage of basing the gasification/liquidization equipment on a more stable platform.

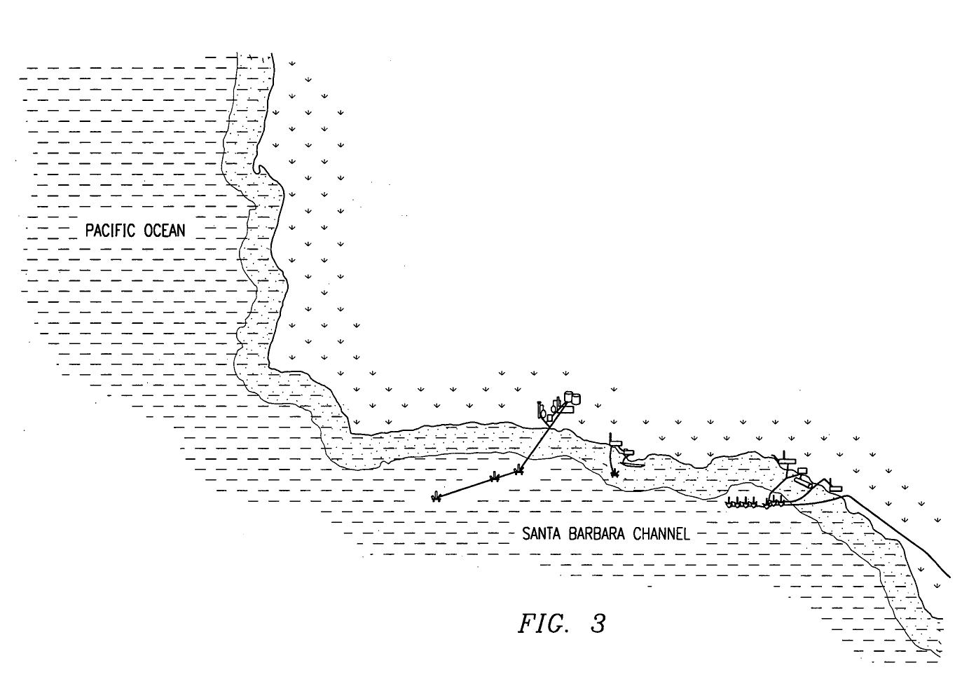

FIG. 3 shows the location of one place where the present invention can be implemented.

While the invention has been particularly shown and described with reference to a preferred embodiment, it will be understood by those skilled in the art that various changes in form and detail may be made therein without departing from the spirit and scope of the invention.

1. A method of delivering liquefied natural gas (LNG) to a destination, comprising:
supplying an amount of LNG to gasification equipment;
converting the LNG into natural gas;
inserting the natural gas into a pipeline located offshore; and
delivering the natural gas to an existing natural gas pipeline system.

2. The method as described in claim 1, wherein the supplying step further includes supplying the LNG using a ship.

3. The method as described in claim 1, wherein the pipeline located offshore is associated with an existing gas well.

4. The method as described in claim 1, wherein the gasification equipment is located on a barge.

5. The method as described in claim 1, wherein the converting step further comprises applying heat to the LNG through a vaporizer.

6. A system for delivering liquefied natural gas (LNG) to a destination, comprising:
a container of LNG;
gasification equipment connected to the container of LNG, wherein the gasification equipment converts the LNG to natural gas;
an offshore pipeline connected to the gasification equipment, wherein the natural gas produced by the gasification equipment is inserted into the offshore pipeline thereby providing natural gas to entitles connected to the pipeline.

7. The system as described in claim 6, wherein the container of LNG is a ship.

8. The system as described in claim 6, wherein the offshore pipeline is associated with an existing gas well.

9. The system as described in claim 6, wherein the gasification equipment is located on a barge.

10. The system as described in claim 6, further comprising a vaporizer to apply heat to the LNG.

11. A system for delivering liquefied natural gas (LNG) to a destination, comprising:
a container means for containing LNG;
a gasification means for converting the LNG to natural gas, the gasification means being connected to the container of LNG;
an offshore pipeline connected to the gasification equipment, wherein the natural gas produced by the gasification means is inserted into the offshore pipeline thereby providing natural gas to entitles connected to the pipeline.

12. The system as described in claim 11, wherein the container means is a ship.

13. The system as described in claim 11, wherein the offshore pipeline is associated with an existing gas well.

14. The system as described in claim 11, wherein the gasification means is located on a barge.

15. The system as described in claim 11, further comprising a vaporization means for vaporizing the LNG by applying heat.
